(19) United States
(12) Patent Application Publication
(10) Pub. No.: US 2018/0028046 A1
(43) Pub. Date: Feb. 1, 2018

(54) SYSTEMS AND METHODS FOR A HAIR AND LINT REMOVER

(71) Applicant: Nite Ize, Inc., Boulder, CO (US)

(72) Inventors: Darren Macca, Longmont, CO (US); Andrew Valentine, Denver, CO (US)

(21) Appl. No.: 15/662,561

(22) Filed: Jul. 28, 2017

Related U.S. Application Data
(60) Provisional application No. 62/368,474, filed on Jul. 29, 2016.

(51) Int. Cl. A47L 25/00; B08B 7/00; A01K 13/00

(52) U.S. Cl. CPC A47L 25/00; A01K 13/002; B08B 7/00; A46B 5/00

(57) ABSTRACT

An apparatus for removing hair includes a first body portion, the first body portion composed of a high friction material; and a second body portion, the first body portion at least partially surrounding the second body portion, the second body portion providing rigid support to the first body portion.

### CROSS-REFERENCE TO RELATED APPLICATION

This application claims the benefit of U.S. Provisional Application No. 62/368,474, filed on Jul. 29, 2016, which is incorporated herein by reference in its entirety.

### BACKGROUND

Many surfaces collect hair and lint that our in the environment, especially that originating from animals. Additionally, animals may need to be brushed frequently in order to reduce the occurrence of hair and lint on upholstery, clothing, or other surfaces. Therefore, it is desirable to have a convenient and effective tool for frequently removing hair and lint from these types of surfaces. It may also be desirable to have a tool for removing hair from animals.

### BRIEF SUMMARY

In one embodiment, an apparatus for removing hair includes a first body portion, the first body portion composed of a high friction material; and a second body portion, the first body portion at least partially surrounding the second body portion, the second body portion providing rigid support to the first body portion. Optionally, the apparatus further includes a carabineer portion integrated with the second body portion. In one alternative, the durometer of the first body portion is approximately 35 shore A. Alternatively, the second body portion is Polyamid PA 6 with 15-20% Glass Fiber. In another alternative, the durometer of the first portion is approximately 20 shore A to 50 shore A. Optionally, the high friction material is rubber, latex, silicon, TPE (thermoplastic elastomer), or TPR (thermoplastic rubber). Alternatively, the high friction material is Teknor Apex Monprene 2830E. Optionally, the first body portion include a first edge with a plurality of comb-like protrusions. Alternatively, the first body portion includes a squeegee portion. Optionally, the squeegee portion is a double squeegee including a first and second outer flap, a central flap, and a first and second channel oriented between the first outer flap and the central flap and the second outer flap and the central flap.

In another embodiment, an apparatus for removing hair, lint, fuzz, or other materials includes a first body portion composed of a high friction material, the first body portion including a squeegee portion. Optionally, the squeegee portion is a double squeegee including a first and second outer flap, a central flap, and a first and second channel oriented between the first outer flap and the central flap and the second outer flap and the central flap. Alternatively, the apparatus further includes a second portion, the first body portion at least partially surrounding the second body portion, the second body portion providing rigid support to the first body portion. Optionally, the high friction material is a material selected from the list consisting of a rubber, latex, silicon, TPE (thermoplastic elastomer), and TPR (thermoplastic rubber). Alternatively, the second body portion is Polyamid PA 6 with 15-20% Glass Fiber and the high friction material is Teknor Apex Monprene 2830E. In another alternative, the durometer of the first body portion is approximately 35 shore A. Optionally, the durometer of the first portion is approximately 20 shore A to 50 shore A. Alternatively, the first body portion include a first edge with a plurality of comb-like protrusions.

In one embodiment, a method of capturing hair from a surface includes providing a tool with a first body portion, the first body portion composed of a high friction material and a second body portion, the first body portion at least partially surrounding the second body portion, the second body portion providing rigid support to the first body portion. The method further includes running the tool across the surface and capturing hair with the high friction material. Optionally, the durometer of the first body portion is approximately 35 shore A. Alternatively, the durometer of the first portion is approximately 20 shore A to 50 shore A. Optionally, the second body portion is Polyamid PA 6 with 15-20% Glass Fiber and the high friction material is Teknor Apex Monprene 2830E. In another configuration the method further includes: washing the hair from the first body portion with water.

### BRIEF DESCRIPTION OF THE DRAWINGS

FIG. 1 show a side view of one embodiment of a hair removal tool;

FIG. 2 shows the interior portion of the hair removal tool of FIG. 1;

FIG. 3 shows a bottom view of the hair removal tool of FIG. 1.

### DETAILED DESCRIPTION

Certain terminology is used herein for convenience only and is not to be taken as a limitation on the embodiments of the systems and methods for a Hair and Lint Remover. Embodiments of the hair and lint remover are primarily used for capturing hair from surfaces, including upholstery and clothing. Alternative designs may use similar apparatuses to capture hair directly from animals. In the drawings, the same reference numbers are employed for designating the same elements throughout the several figures.

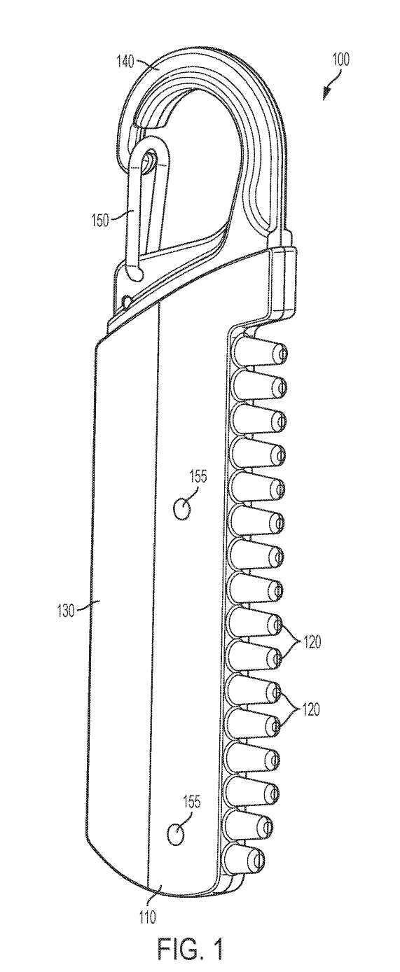

FIG. 1 show a side view of one embodiment a hair removal tool. Hair removal tool 100 includes a first body portion 110. First body portion 110 is composed of a material that provides a high friction surface. This material is typically a rubber, latex, silicon, TPE (thermoplastic elastomer), or TPR (thermoplastic rubber). In many embodiments, an important characteristic of the material is the durometer. In many embodiments the durometer will be in a range that provides for a soft material. Due to the compressibility of the soft material, a higher friction surface is created. This high friction surface assists in the removal of lint, fuzz, hair, or other small particles. This is typically performed on surfaces such as upholstery, clothing, or other surfaces. Alternative embodiments may be designed to remove hair from animals directly. In some embodiments, the first body portion is formed of a material having a durometer of approximately 35A. In many embodiments the material is in the durometer range of approximately 20A to 50A. In many embodiments the material is Teknor Apex Monprene 2830E or equivalent. In some alternatives, first body portion 110 (the overmold) is made of starprene 360S-40 (durometer 40 A). In some embodiments the material is silicon.

First body portion 110 includes a plurality of projections 120. These projections 120 in the embodiment shown approximately resemble comb or brush bristles, although a variety of different projections are possible. The operating principle of projections 120 is to provide an area having increased surface area and locations where hair or other material may contact more than one surface of projections 120. Finer bristles having a decreased width and closer spacing are possible. In many embodiments, a balance may be struck concerning the length of the projections, the width of the projections, and the rigidity (durometer) of the material. In some cases, projections that are exceedingly flexible due to a combination of their length, width, and the rigidity, may be less effective in capturing hair/lint. Many embodiments of the hair removal tool may be used on surfaces. In alternatives, the hair removal tool may be used on animals themselves. The projections may be most useful when interacting with irregular surfaces. Alternatives may be designed for brushing an animal's fur.

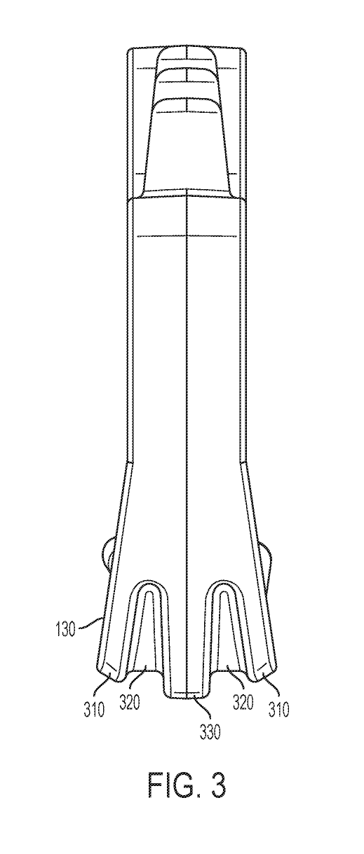

Additionally, first body portion 110 includes a double squeegee section 130. This section also assists in removing hair/lint. This double squeegee section 130 will be further described in relation to FIG. 3.

First body portion 110 is interconnected with a second body portion 140. Section body portion 140 includes a carbineer section 150. This carabineer section 150 allows for ready attachment to a key chain or other location. One issue that users frequently face with hair and lint removal is the unavailability of a tool when needed. By providing a key chain attachment mechanism, the hair removal tool 100 may be readily available. Second body portion 140 may include nubs 155 that assist in the retention and attachment of second body portion 140 to first body portion 110.

In various embodiments second body portion 140 may not include carabineer section 150. Instead second body portion may include various additional sections. For instance a larger handle may be included, a hook, an eyelet, or other attachment. One of the functions of second body portion is to provide structural support to the first body portion. Since the durometer of the first body portion is so soft, it has poor rigidity and it may be unable to properly function at a lint/hair removing tool. In some embodiments, second body portion 140 is composed of Polyamid PA 6, 15-20% Glass Fiber. Such a material binds may bind well to TPE. In various embodiments, the second body portion may be composed of various other materials, including but not limited to metal, wood, plastics, or any other material that may provide rigidity. In some embodiments, the first body portion may completely cover the second body portion.

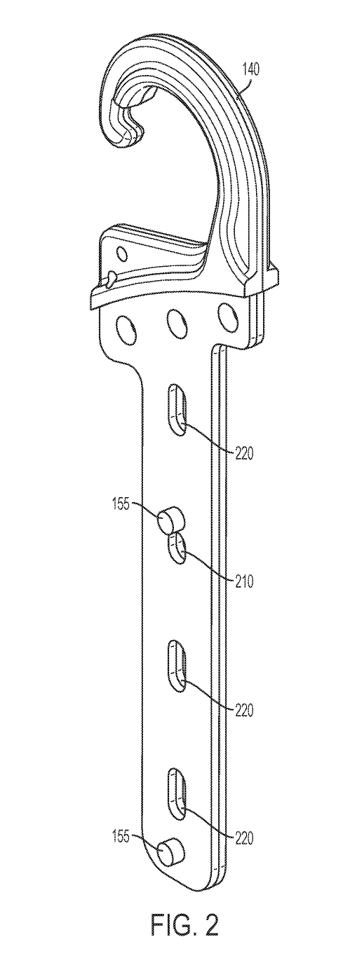

FIG. 2 shows a more detailed view of second body portion 140. As shown in FIG. 2, second body portion 140 includes a rigid portion 210 that runs the length of the hair removal tool 100. This provides rigidity to the hair removal tool 100. The rigidity of the second body portion may vary. By rigid, it is not necessarily meant that the second body portion does not flex at all. In many embodiments a relatively thin nylon and glass fiber second body portion is utilized. This will add significant stiffness to the hair removal tool 100, however, the second body portion and the device will still flex significantly. In many embodiments, the carabineer portion 150 is made much thicker that the second body portion 140 that provides for support to the first body portion 110. In such a case, the carabineer portion 140 will flex a minimum amount under typical usage and/or pressure applied by the human hand. In alternatives, where carabineer portion 140 is replaced by a handle; the handle will typically be more rigid as well. Rigid portion 210 may have a variety of alternative shapes and may have shapes that assist in directly supporting projections 120 and double squeegee 130 or other hair/lint removers. Rigid portion 210 as shown includes cutouts 220. Cutouts 220 may serve to enhance the binding of first body portion 110 to second body portion 140. As previously mentioned, second body portion 150 includes nubs 155, also assisting in the attachment. In the embodiment shown, the hair removal tool 100 is not specifically designed for a deep combing of an animal that gathers a significant amount of un-freed hair, but instead focuses on gathering loose hairs from surfaces. In embodiments, the specific design of the squeegee and unsupported teeth/protrusions gather already freed hair.

FIG. 3 shows a bottom view of the hair removal tool 100, highlighting the double squeegee section 130. As shown double squeegee section 130 includes a first and second outer flap 310, a central flap 330, and a first and second channel 320. The first and second channel 320 serve to capture hair turning the scraping/removal process. The squeegee portion may be especially effective in removing hair from smoother surfaces and fabrics that are relatively smooth.

One advantage of a system utilizing TPE and a second body portion that may bond to TPE is that it may be injection molded, therefore, decreasing production costs. Some high friction materials (by virtue of their low durometer) may not be easily injection molded, which may increase production costs (such as silicon).

Although a particular embodiment is shown in the figures, various other shapes and configurations may be produced. For instance, shapes that resemble various combs or brushes may be utilized as well as other useful shapes such as cylinders, flat rectangular cubes, flat elliptical prisms, concave and convex curves, as well as a variety of shapes. The first body section of high friction material may cover various portions of the second body portion. The second body portion, which forms the rigid part of the hair removal tool, may be shaped in various ways such that various portions of the first body portion are supported to different degrees. For instance, as shown in the figures, the second body portion may merely support the longitudinal portion of the tool. In other instances, the second body portion may directly support the teeth or protrusions of the tool or support other features of the tool. In some embodiments the hair removal tool may be categorized as a hair removal tool having a polyamid frame and a TPE coating. In some embodiments, the hair removal tool may be described as a body covered with a polymer having a specific durometer. In some configurations this durometer is approximately 35 shore A. In some configurations, this durometer is in the range of 20-50 shore A. In some embodiments, the hair removal tool includes a tool with a double squeegee.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

What is claimed as new and desired to be protected by Letters Patent of the United States is:

1. A apparatus for removing hair, the apparatus comprising:
a first body portion, the first body portion composed of a high friction material;
a second body portion, the first body portion at least partially surrounding the second
body portion, the second body portion providing rigid support to the first body portion.

2. The apparatus of claim 1, further comprising a carabineer portion integrated with the second body portion.

3. The apparatus of claim 1, wherein the durometer of the first body portion is approximately 35 shore A.

4. The apparatus of claim 1, wherein the second body portion is Polyamid PA 6 with 15-20% Glass Fiber.

5. The apparatus of claim 1, wherein the durometer of the first portion is approximately 20 shore A to 50 shore A.

6. The apparatus of claim 1 wherein the high friction material is a material selected from the list consisting of a rubber, latex, silicon, TPE (thermoplastic elastomer), and TPR (thermoplastic rubber).

7. The apparatus of claim 1, wherein the high friction material is Teknor Apex Monprene 2830E.

8. The apparatus of claim 1, wherein the first body portion include a first edge with a plurality of comb-like protrusions.

9. The apparatus of claim 1, wherein the first body portion includes a squeegee portion.

10. The apparatus of claim 9 wherein the squeegee portion is a double squeegee including a first and second outer flap, a central flap, and a first and second channel oriented between the first outer flap and the central flap and the second outer flap and the central flap.

11. An apparatus for removing hair, lint, fuzz, or other materials, the apparatus comprising:
a first body portion composed of a high friction material, the first body portion including a squeegee portion.

12. The apparatus of claim 11 wherein the squeegee portion is a double squeegee including a first and second outer flap, a central flap, and a first and second channel oriented between the first outer flap and the central flap and the second outer flap and the central flap.

13. The apparatus of claim 11, further comprising a second portion, the first body portion at least partially surrounding the second body portion, the second body portion providing rigid support to the first body portion.

14. The apparatus of claim 11 wherein the high friction material is a material selected from the list consisting of a rubber, latex, silicon, TPE (thermoplastic elastomer), and TPR (thermoplastic rubber).

15. The apparatus of claim 13, wherein the second body portion is Polyamid PA 6 with 15-20% Glass Fiber and the high friction material is Teknor Apex Monprene 2830E.

16. The apparatus of claim 11, wherein the durometer of the first body portion is approximately 35 shore A.

17. The apparatus of claim 11, wherein the durometer of the first portion is approximately 20 shore A to 50 shore A.

18. The apparatus of claim 11, wherein the first body portion include a first edge with a plurality of comb-like protrusions.

19. A method of capturing hair from a surface, the method comprising:
providing a tool with a first body portion, the first body portion composed of a high friction material and a second body portion, the first body portion at least partially surrounding the second body portion, the second body portion providing rigid support to the first body portion;
running the tool across the surface and capturing hair with the high friction material.

20. The method of claim 18 wherein the durometer of the first body portion is approximately 35 shore A.

21. The method of claim 18, wherein the durometer of the first portion is approximately 20 shore A to 50 shore A.

22. The method of claim 18, wherein the second body portion is Polyamid PA 6 with 15-20% Glass Fiber and the high friction material is Teknor Apex Monprene 2830E.

23. The method of claim 18, further comprising: washing the hair from the first body portion with water.
